(19) United States
(12) Patent Application Publication
(10) Pub. No.: US 2004/0200151 A1
(43) Pub. Date: Oct. 14, 2004

(54) Vehicle weatherstrip

(76) Inventors: Anthony E. Tognetti, Howell, MI (US); Thomas J. Sienkowski, Fenton, MI (US); Christopher D. Schneider, Wabash, IN (US)

Correspondence Address: David D. Murray, BRINKS HOFER GILSON & LIONE, P.O. Box 10395, Chicago, IL, 60610, US

(21) Appl. No.: 10/804,306

(22) Filed: Mar. 19, 2004

Related U.S. Application Data
(60) Provisional application No. 60/456,172, filed on Mar. 20, 2003.

(51) Int. Cl. E05F 11/38

(52) U.S. Cl. 49/377; 49/475.1

(57) ABSTRACT

A weatherstrip for a motor vehicle includes a generally U or J-shaped body of thermoplastic olefin (TPO), polypropylene (PP) having integrally formed lips or sealing flanges of more flexible thermoplastic vulcanizates (TPV) and a show surface of thermoplastic polyolefin (TPO). The body includes longitudinally spaced apart latch members which secure the weatherstrip to a vehicle body. The sealing flanges preferably include flocking on the surfaces which contact and ride against the window glass. The thermoplastic polyolefin show surface bonds directly to the TPV or polypropylene substrate and provides a color and gloss match to the paint on the vehicle body. Improved weatherstrip performance and improved vehicle appearance are both achieved by the present invention.

### CROSS-REFERENCE TO RELATED APPLICATIONS

This patent application claims the benefit of U.S. Provisional Application Serial No. 60/456,172, filed on Mar. 20, 2003 and entitled “WEATHERSTRIP.”

### BACKGROUND OF THE INVENTION

1. Field of the Invention

The invention relates generally to weatherstrips for motor vehicles and more specifically to an extruded weatherstrip having a thermoplastic polyolefin (TPO) show surface.

2. Related Art

Most motor vehicles are equipped with at least two windows that slide in a window opening from an up or extended position that seals off the opening to a down position, retracted within the vehicle body, that opens all or a portion of the window opening and allows an exchange of air between the inside and outside of the vehicle. A sealing device broadly referred to as a weatherstrip is disposed about the periphery of the window opening and provides an air and water tight seal between the vehicle body or door and the window.

The weatherstrip along the horizontal top and vertical sides of the window opening are referred to as a glass run weatherstrip whereas the portion of the weatherstrip disposed between the door or body and the lower extremity of the window opening is typically referred to as a beltstrip. The beltstrip hides the interface between the window and the door or body and provides a wiper flange or blade for cleaning the window as it raises and lowers from or into the body or door of the vehicle.

Significant design attention has been directed to vehicle streamlining to reduce both drag and wind noise. To achieve these goals, weatherstrip designs seek to eliminate gaps and complex surfaces. Designs which overlap the window are also favored. Additional goals of contemporary weatherstrip configurations are ease of installation, serviceability and durability.

Weatherstrips and beltstrips are generally extruded or roll-formed in a complicated manufacturing process having many steps. In one process, a metal core structure is formed and coated with an extruded layer of elastomeric material to form a belt molding and then is cut to length. A sealing strip having a flexible blade for contacting the window may be formed and coated in an extrusion process with rubber or similar material to form a beltstrip. An inner surface of the blade is generally flocked to provide a low friction coating for reducing drag between the blade and the window and to reduce the tendency of the weatherstrip and window to squeak. The sealing strip is then affixed to the belt molding. The belt molding is typically notched at spaced locations. Clips are then inserted into the notches to fix the belt molding and sealing strip to the vehicle by griping a flange or edge formed in the door body of the vehicle.

### BRIEF SUMMARY OF THE INVENTION

A weatherstrip for a motor vehicle includes a generally U or J-shaped body of thermoplastic olefin (TPO) or polypropylene (PP) having integrally formed lips or sealing flanges of more flexible material such as a thermoplastic elastomer (TPE), preferably a thermoplastic vulcanizate (TPV) and a show surface of thermoplastic polyolefin (TPO). The body includes longitudinally spaced apart latch members which secure the weatherstrip to a vehicle body. The sealing flanges preferably include flocking on the surfaces which contact and ride against the window glass. The thermoplastic polyolefin show surface bonds directly to the TPO or polypropylene substrate and provides a color and gloss match to the paint on the vehicle body. Improved weatherstrip performance and improved vehicle appearance are both achieved by the present invention.

Thus it is an object of the present invention to provide a vehicle weatherstrip having a generally U or J-shaped body including a show surface of thermoplastic olefin.

It is a further object of the present invention to provide a weatherstrip for a motor vehicle having a generally U or J-shaped body of polypropylene and including integrally formed lips or sealing flanges.

It is a still further object of the present invention to provide a weatherstrip of a motor vehicle having a generally U or J-shaped body including spaced apart latch members and a show surface of thermoplastic olefin.

It is a still further object of the present invention to provide a weatherstrip for a motor vehicle having a generally U or J-shaped body and a show surface of thermoplastic olefin having a color and gloss that matches that of the vehicle.

Further objects and advantages of the present invention will become apparent by reference to the following description of the preferred embodiment and appended drawings wherein like reference numbers refer to the same component, element or feature.

### BRIEF DESCRIPTION OF THE DRAWINGS

FIG. 1 is a fragmentary, side elevational view of a motor vehicle having the weatherstrip of the present invention installed thereon;

FIG. 2 is a full sectional view of a weatherstrip according to the present invention taken along line 2-2 of FIG. 1; and

FIG. 3 is an enlarged, full sectional view of a weatherstrip according to the present invention.

### DETAILED DESCRIPTION OF THE INVENTION

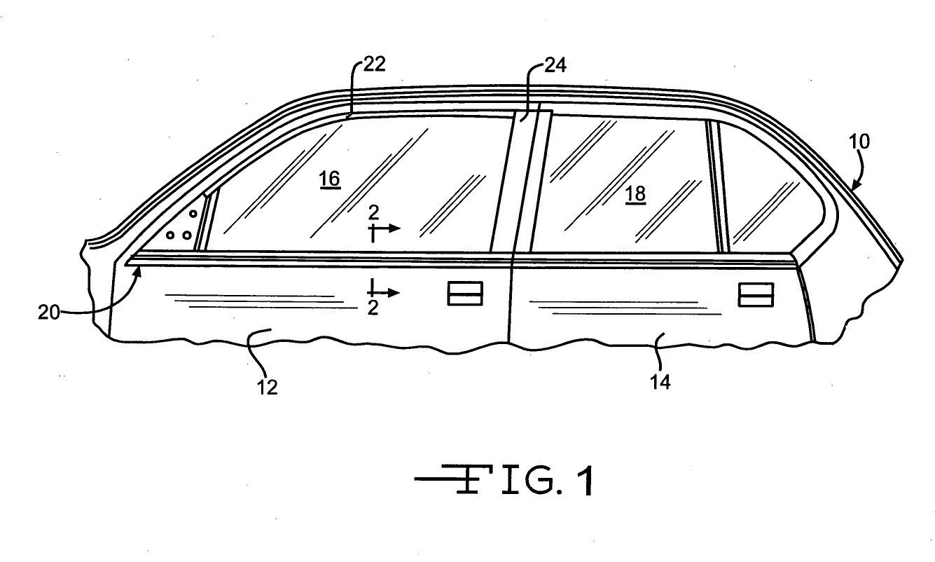

Referring now to FIG. 1, a side elevational view of a portion of a motor vehicle is illustrated and generally designated by the reference number 10. The motor vehicle 10 includes a front door 12 and a rear door 14 having respective front and rear lights or windows 16 and 18. A weatherstrip or beltstrip assembly 20 is disposed at the interface between the front door 12 and the front window 16. Additional weatherstrips 22 may be disposed about the first window 16 and a door frame 24 as well as the rear window 18 in accordance with conventional practice.

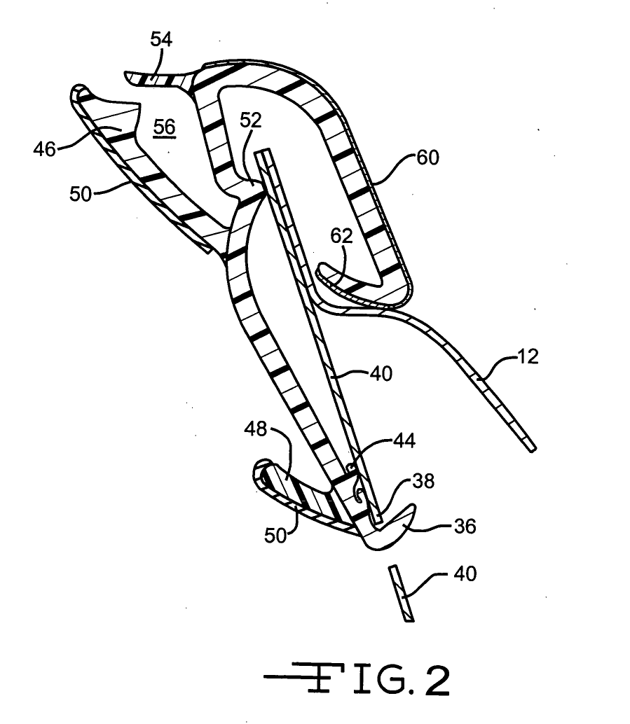

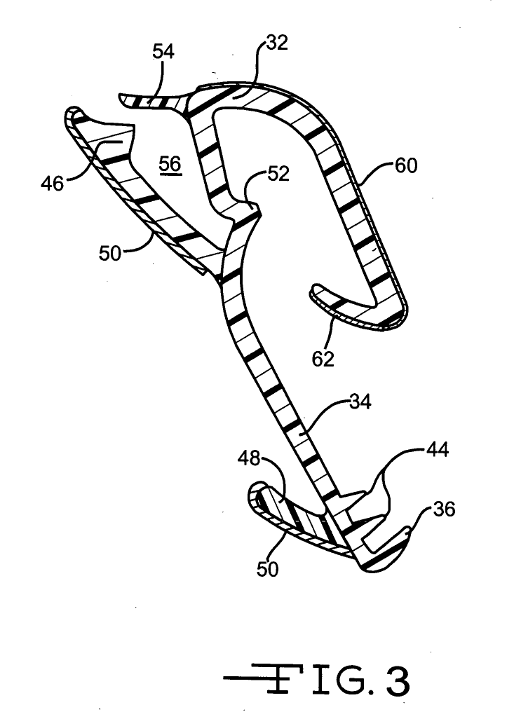

Referring now to FIGS. 2 and 3, the beltstrip assembly 20 includes a generally U or J-shaped body 32 having a first or shorter portion and a second, longer leg or extension 34. The extension 34 terminates in a large flange or latch member 36 that engages a lower edge 38 of a door panel 40. The terminal portion of the extension 34 and the latch member 36 may be continuous or discontinuous, i.e., having notches or open regions, to match corresponding regions in the door panel 40. The door panel 40 is a portion of the front door 12. The inner (upper) surface of the latch member 36 is oriented relative to the extension 34 such that it retains the beltstrip assembly 20 on the door 12 once it has been snapped over the lower edge 38 of the door panel 40. A pair of smaller, more flexible ears or flanges 44 also engage the door panel 40 and minimize the likelihood of rattles or sympathetic vibration of the beltstrip assembly 20 on the door panel 40.

The body 32 and extension 34 are preferably extruded of polymeric material such as a thermoplastic polyolefin (TPO) or polypropylene (PP) or a blend of these materials containing talc or other suitable filler. A preferred material that is commercially available from DSM Engineering Plastics Products, Inc., Evansville, Indiana under the trade designation FIBERFIL M-2450 comprises a polypropylene polyethylene copolymer blend containing about 20% talc filler. Additionally, the material may contain carbon black or other pigment to achieve a desired color.

The beltstrip assembly 20 also includes a pair of spaced apart generally parallel upper and lower lips or flanges 46 and 48. The upper and lower lips or flanges 46 and 48 both include a surface treatment of flocking 50. The flocking 50 reduces friction between the flanges 46 and 48 which provide an air and liquid seal between the beltstrip assembly 20 and the window 16, illustrated in FIG. 1. Moreover, as the window 16 is raised or lowered, the flanges or lips 46 and 48 remove water from the surface of the window 16. The body 32 also defines an inward crease or projection 52 that may engage the door panel 40 to laterally locate the beltstrip assembly 20. A small, thin hider lip or flange 54 extends toward the upper flange 46 from the upper region of the body 32 of the beltstrip assembly 20. As the upper flange 46 flexes toward the body 32 of the beltstrip assembly 20 the hider flange 54 cooperates to close off an interior region 56 between the upper flange or lip 46 and an adjacent portion of the body 32.

The flanges 46, 48 and 54 are preferably formed of a thermoplastic elastomeric material (TPE). A preferred TPE material is a thermoplastic vulcanizate (TPV) available from DSM Thermoplastic Elastomers, Inc., under the trade designation SARLINK. Preferably, the body 32, including the extension 34 and the flanges 46, 48 and 54, may be co-extruded as the TPE or TPV material will bond directly to the thermoplastic plastic olefin and polypropylene materials.

On the outer surface of the body 32, on that region known as the show region or show surface, is a thin layer of material 60. Preferably, the layer of material 60 is on the order of 100 to 200 microns in thickness but may be as thin as 50 microns and as thick as 500 microns or thicker. The layer of material 60 is formed of a thermoplastic olefin having high gloss and scratch resistance. A preferred material is a thermoplastic olefinic elastomer commercially available from Solvay, Auburn Hills, Mich. under the trade designation SOLVAY Indure 1600.

The preferred material is believed to be composed predominantly of a blend of polypropylene polymers and an ethylene-propylene elastomer, which blend constitutes more than 95 weight percent of the material. The balance of the preferred material is believed to include calcium sterate and an esterphenol compound. The material may also contain carbon black or other suitable pigment to achieve a desired color. The esterphenol compound is believed to contribute significantly to the improved gloss and scratch resistant of the layer of material 60.

As noted, the beltstrip assembly 20 provides a color matched show surface which is both durable and aesthetically pleasing. Furthermore, since the layer of TPO material 60 is elastic, the beltstrip assembly 20 can be manipulated, i.e., curved or bent, to fit vehicle contours without degrading its appearance. It should also be appreciated that since the layer of thermoplastic olefin (TPO) material 60 will bond directly to the thermoplastic olefin (TPO) or polypropylene (PP) of the body 32, the entire beltstrip assembly 20 may be coextruded in one operation. Finally, it should be appreciated that while described above as a beltstrip, it should be appreciated that the product will function in different door and window locations and orientations and may thus be accurately characterized as a weatherstrip.

The foregoing disclosure is the best mode devised by the inventors for practicing this invention. It is apparent however, that devices incorporating modifications and variations will be obvious to one skilled in the art of weatherstrips for motor vehicles. Inasmuch as the foregoing disclosure presents the best mode contemplated by the inventors for carrying out the invention and is intended to enable any person skilled in the pertinent art to practice this invention, it should not be construed to be limited thereby but should be construed to include such aforementioned obvious variations and be limited only by the spirit and scope of the following claims.

1. A weatherstrip for a window opening of a motor vehicle comprising, in combination,
a generally U-shaped body having a first, shorter leg having a first end and a second, longer leg having a second end,
a latch member disposed on said second end,
a first and a second spaced apart flange extending from said second leg, said flanges each including a surface having flocking disposed thereupon,
said shorter leg having a show surface including a layer of thermoplastic olefin material.

2. The weatherstrip for a window opening of a motor vehicle according to claim 1 wherein said first end includes a member adapted to contact a body of a motor vehicle.

3. The weatherstrip for a window opening of a motor vehicle according to claim 2 wherein said member adapted to contact a body of a motor vehicle includes a surface having flocking disposed thereupon.

4. The weatherstrip for a window opening of a motor vehicle according to claim 1 further including a pair of small flanges disposed adjacent said latch member on said second, longer leg.

5. The weatherstrip for a window opening of a motor vehicle according to claim 1 wherein said flanges are formed of a thermoplastic elastomer.

6. The weatherstrip for a window opening of a motor vehicle according to claim 1 wherein said layer is less than 500 microns thick.

7. The weatherstrip for a window opening of a motor vehicle according to claim 1 wherein said latch member is discontinuous.

8. The weatherstrip for a window opening of a motor vehicle according to claim 1 formed by coextrusion.

9. A weatherstrip for a motor vehicle comprising, in combination,
a J-shaped body having a first, shorter leg having a first end and a second, longer leg having a second end,
a latch member disposed on said second end,
a first and a second spaced apart flanges extending from said second leg, said flanges each including a surface having flocking disposed thereupon,
said shorter leg having a show surface covered with a layer of thermoplastic olefin material.

10. The weatherstrip for a motor vehicle according to claim 9 wherein said shorter leg has an end and said body includes a member adapted to contact a body of a motor vehicle.

11. The weatherstrip for a motor vehicle according to claim 10 wherein said member adapted to contact the body of a motor vehicle includes a surface having flocking disposed thereupon.

12. The weatherstrip for a motor vehicle according to claim 9 further including a pair of small ribs disposed adjacent said latch member on said second leg.

13. The weatherstrip for a motor vehicle according to claim 9 wherein said thin layer is less than 500 microns thick.

14. The weatherstrip for a motor vehicle according to claim 9 wherein said flanges are formed of a thermoplastic elastomer.

15. The weatherstrip for a window opening of a motor vehicle according to claim 9 formed by coextrusion.

16. A weatherstrip for a motor vehicle comprising, in combination,
a U-shaped body having a first leg having a first end and a second leg having a second end,
a latch member disposed on said second end,
a first and a second spaced apart flanges extending from said second leg, said flanges each including a surface having flocking disposed thereupon,
said first leg having a show surface covered with a layer of thermoplastic olefin material.

17. The weatherstrip for a motor vehicle according to claim 16 further including a pair of small flanges disposed adjacent said latch member on said second, longer leg.

18. The weatherstrip for a motor vehicle according to claim 16 wherein said flanges are formed of a thermoplastic elastomer.

19. The weatherstrip for a motor vehicle according to claim 16 wherein said layer is less than 500 microns thick.

20. The weatherstrip for a motor vehicle according to claim 16 wherein said latch member is discontinuous.
